(19) United States
(12) Patent Application Publication
(10) Pub. No.: US 2016/0065097 A1
(43) Pub. Date: Mar. 3, 2016

(54) PIEZOELECTRIC ENERGY HARVESTER AND WIRELESS SWITCH INCLUDING THE SAME

(71) Applicant: SAMSUNG ELECTRO-MECHANICS CO., LTD., Suwon-si (KR)

(72) Inventors: In Wha JEONG, Suwon-si (KR); Jong Heum PARK, Suwon-si (KR); Hyung Jin LIM, Suwon-si (KR)

(73) Assignee: SAMSUNG ELECTRO-MECHANICS CO., LTD., Suwon-si (KR)

(21) Appl. No.: 14/836,604

(22) Filed: Aug. 26, 2015

(30) Foreign Application Priority Data
Sep. 1, 2014 (KR) 10-2014-0115723
Apr. 23, 2015 (KR) 10-2015-0057010

(51) Int. Cl. H02N 2/18; H05B 37/02

(52) U.S. Cl. CPC H02N 2/181; H02N 2/18; H05B 37/02

(57) ABSTRACT

A piezoelectric energy harvester includes a thin film member, a support member situated to support the center or an edge of the thin film member, a piezoelectric member situated on the thin film member, and a driving member situated on the thin film member, situated to be misaligned with the support member, and configured to press the edge or the center of the thin film member. Such a design provides improved durability and functionality for a piezoelectric

### CROSS-REFERENCE TO RELATED APPLICATION(S)

This application claims the benefit under 35 USC 119(a) of Korean Patent Application Nos. 10-2014-0115723 filed on Sep. 1, 2014, and 10-2015-0057010 filed on Apr. 23, 2015 in the Korean Intellectual Property Office, the entire disclosures of which are incorporated herein by reference for all purposes.

### BACKGROUND

1. Field

The following description relates to a piezoelectric energy harvester and a wireless switch including the same.

2. Description of Related Art

Generally, a wireless lighting control system includes a lighting part in which a power module and a communications module are embedded, a wireless controller, a network device that connects the lighting part and the wireless controller, and an illumination sensor.

However, since a separate wireless lighting controller and a separate network device are required in one approach to providing a wireless lighting control system, the structure of such a wireless lighting control system has become more complicated and manufacturing costs have increased.

It may be difficult to apply a wireless lighting control system in homes, offices, or other scenarios where a wireless lighting control system would otherwise be useful, due to the issues as described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present examples provides a piezoelectric energy harvester providing driving power to a wireless transmission module provided in a wireless switch.

An aspect of the present examples also provides a piezoelectric energy harvester capable of having increased lifetime by significantly decreasing impacts at the time of driving.

According to an aspect of the present examples, a piezoelectric energy harvester includes a thin film member, a support member situated to support the center or an edge of the thin film member, a piezoelectric member situated on the thin film member, and a driving member formed on the thin film member, situated to be misaligned with the support member, and configured to press the edge or the center of the thin film member.

In one general aspect, a piezoelectric energy harvester includes a thin film member, a support member situated to support a center or an edge of the thin film member, a piezoelectric member situated on the thin film member, and a driving member situated on the thin film member, situated to be misaligned with respect to the support member, and configured to press the center or the edge of the thin film member.

An edge of the support member may have a curved shape.

The piezoelectric energy harvester may further include electrodes situated on the thin film member and connected to the piezoelectric member.

The support member may be situated to support the center of the thin film member.

The driving member may be situated to press the edge of the thin film member.

The support member may be situated to support the edge of the thin film member.

The driving member may be situated to press the center of the thin film member.

The thin film member has a circular shape or a hemispherical shape.

The thin film member may radially extend in differing directions.

In another general aspect, a piezoelectric energy harvester includes thin film members, support members situated to support both ends of each of the thin film members, piezoelectric members situated on the thin film members, a connection member connecting the centers of the thin film members, and a driving member situated on the connection member and configured to press the connection member.

In another general aspect, a wireless switch includes a piezoelectric energy harvester including a thin film member extending in both directions based on a support member, a piezoelectric member situated on the thin film member, and a driving member configured to press upon both ends of the thin film member, and a wireless transmission module that transmits electrical signals generated by the piezoelectric energy harvester.

The wireless switch may further include a capacitor that accumulates energy generated from the piezoelectric energy harvester.

The wireless switch may further include a rectifier that rectifies the electrical signals generated from the piezoelectric energy harvester.

The wireless switch may further include a converter that converts the electric signals generated from the piezoelectric energy harvester into a drive voltage suitable for the wireless transmission module.

Other features and aspects will be apparent from the following detailed description, the drawings, and the claims.

### BRIEF DESCRIPTION OF THE DRAWINGS

FIG. 1 is a plan diagram of a wireless switch according to an example.

FIG. 2 is a schematic configuration diagram of the wireless switch according to an example.

FIGS. 3 and 4 are cross-sectional diagrams of a piezoelectric energy harvester according to an example.

FIG. 5 is a perspective diagram of a piezoelectric energy harvester according to another example.

FIG. 6 is a cross-sectional diagram of the piezoelectric energy harvester taken along line A-A of FIG. 5.

FIG. 7 is a plan diagram of a piezoelectric energy harvester according to another example.

FIG. 8 is a plan diagram of a piezoelectric energy harvester according to another example.

FIG. 9 is a plan diagram of a piezoelectric energy harvester according to another example.

FIG. 10 is a side diagram of a piezoelectric energy harvester according to another example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

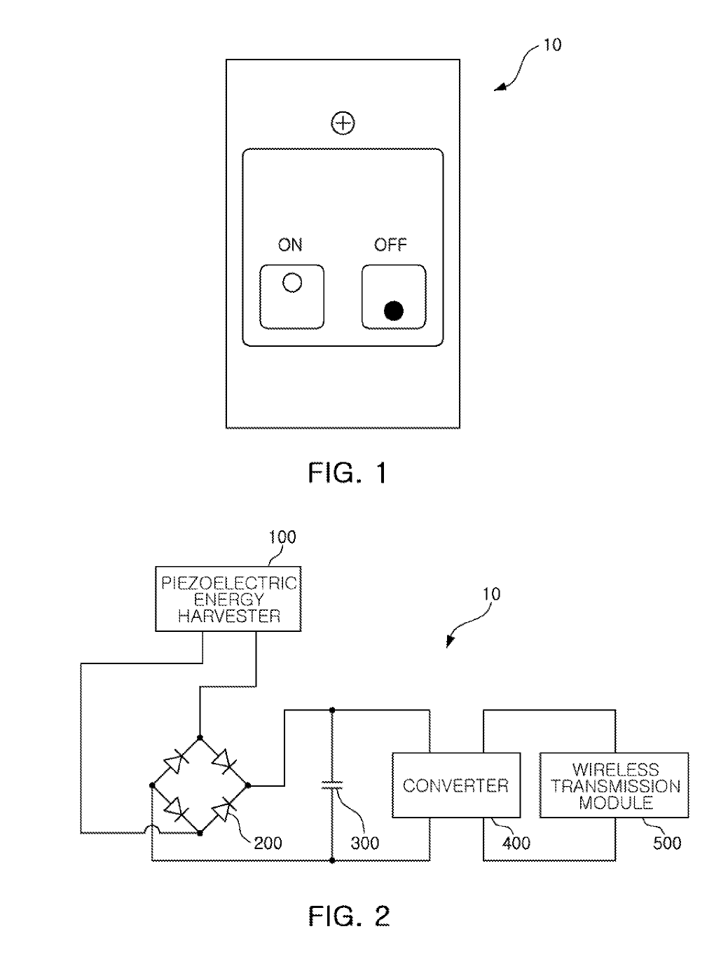

A wireless switch according to an example is described with reference to FIG. 1.

A wireless switch 10 is installed in an area in which a user is able to easily operate the wireless switch 10. For example, the wireless switch 10 is installed on a wall surface, or the like. However, if the wireless switch 10 is installed on a wall surface, the wireless switch 10 is potentially installed on a wall that is conveniently accessible to a user. The wireless switch 10 transmits control signals operating a device disposed at a far-away distance. For example, the wireless switch 10 transmits different wireless signals depending on switching operations of the user to control an on/off operation of a device situated at a far-away distance, for example, a lighting device situated on a ceiling. However, this is only one example, and other examples include lighting devices situated in other locations.

A main configuration of the wireless switch according to an example is described with reference to FIG. 2.

The wireless switch 10, according to the example of FIG. 2, includes a piezoelectric energy harvester 100, a rectifier 200, a capacitor 300, a converter 400, and a wireless transmission module 500.

Energy generated in the piezoelectric energy harvester 100 passes through the rectifier 200, is stored in the capacitor 300, and is converted into stable voltage by the converter 400 to thereby be transferred to the wireless transmission module 500.

The wireless transmission module 500 generates wireless communications signals depending on input signals, and RF communications signals are transferred to a wireless reception module of an external electronic device.

The external electronic device is a lighting device such as a light emitting diode (LED) lamp.

That is, the wireless switch, according to the example, transfers turn-on and turn-off signals to the external electronic device by using the energy generated in the piezoelectric energy harvester 100 as driving power of the wireless transmission module 500.

Therefore, by using such an approach, a wireless control system is simply and easily constructed without using a mechanically complicated configuration for connecting a switch to a lighting device, or a similar switched device, in a home. While this approach is used in the context of switching a lighting device, the approach is also relevant to other devices that are switched on and off.

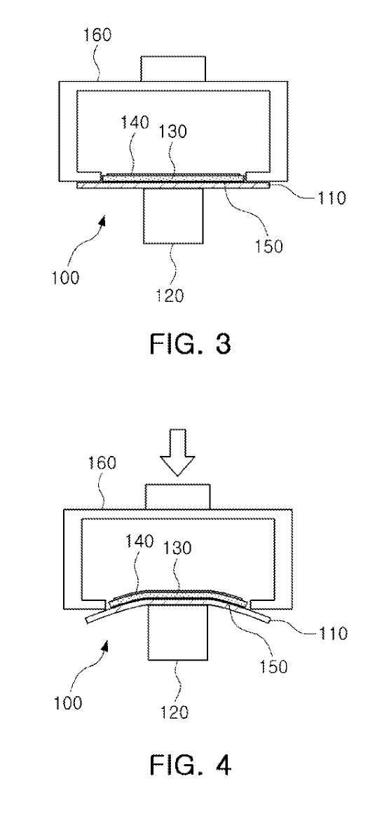

Hereinafter, a configuration of the piezoelectric energy harvester 100, according to the exemplary embodiment, generating energy used as the driving power of the wireless transmission module 500 is further described with reference to the example of FIG. 3.

The piezoelectric energy harvester 100, according to the example, is described further with reference to FIGS. 3 and 4.

First, referring to FIG. 3, the piezoelectric energy harvester 100, according to the example, includes a thin film member 110, a support member 120 supporting the thin film member 110, a piezoelectric member 130 provided on the thin film member 110, an upper electrode 140 provided on one surface of the piezoelectric member 130, a lower electrode 150 provided on the other surface of the piezoelectric member 130, and a driving member 160 generating a displacement in the thin film member 110.

In an example, the thin film member 110 is formed in a plate shape, has elasticity, and is supported by the support member 120.

The support member 120 is disposed on a central portion of a lower surface of the thin film member 110 to support the thin film member 110. Therefore, when external force is applied to one side and the other side of the thin film member 110 in relation to the support member 120, a displacement is generated in portions of the thin film member 110 to which external force is applied.

The piezoelectric member 130 is provided on the thin film member 110. Therefore, when a displacement is generated in the thin film member 110, a displacement is also generated in the piezoelectric member 130, and thus a piezoelectric effect generating a potential difference is generated.

For example, when a displacement is generated in the thin film member 110, a displacement is also be generated in the piezoelectric member 130 provided on the thin film member 110, and thus a electrical polarization occurs in the piezoelectric member 130. The voltage is generated due to the piezoelectric effect, in which an applied mechanical force leads to the generation of electrical energy. Therefore, voltage is generated in the upper electrode 140 provided on one surface of the piezoelectric member 130, and output current generated by the voltage is used as driving power of the wireless transmission module 500.

In examples, the piezoelectric member 130 is formed of lead zirconate titanate, barium titanate (BaTiO₃), lead titanate (PbTiO₃), lithium niobate (LiNbO₃), silicon oxide (SiO₂), or another appropriate material.

The lower electrode 150 is provided in order to generate a potential difference and is thus provided on the other surface of the piezoelectric member 130 so as to correspond to the upper electrode 140.

Next, referring to the example of FIG. 4, when the user presses the driving member 160, an external force is applied to one side and the other side of the thin film member 110 corresponding to the driving member 160, and thus a displacement is generated on the one side and also the other side of the thin film member 110.

When a displacement is generated on one side and the other side of the thin film member 110 with relation to the support member 120, a displacement is also generated on one side and the other side of the piezoelectric member 130 in response to this displacement. As a result, a voltage is generated in the upper electrode 140 situated on one surface of the piezoelectric member 130.

In a case in which both sides of the thin film member 110 are displaced as described above, a displacement distance is relatively decreased, and a voltage equal to or greater than that which would occur in a case of displacing only one of both sides of the thin film member 110 is obtained, and thus impacts required to be applied to the thin film member 110 are decreased.

Therefore, a lifetime of the piezoelectric energy harvester, according to the exemplary embodiment, may be increased.

The voltage generated in the upper electrode 140 is used as driving power of the wireless transmission module 500, and the wireless transmission module 500 transfers wireless communications signals to the external electronic device depending on displacement of the thin film member by the driving member.

As described above, since the piezoelectric energy harvester, according to the example, decreases impacts applied thereto at the time of driving, the lifetime is increased.

Further, the wireless switch, according to the example, uses the voltage generated in the energy harvester as driving power to transfer wireless communications signals to the external electronic device.

Next, a piezoelectric energy harvester according to another example is described. For reference, hereinafter, components that are the same as those in the above-mentioned example are referred to by the same reference numerals and a description thereof is omitted for brevity.

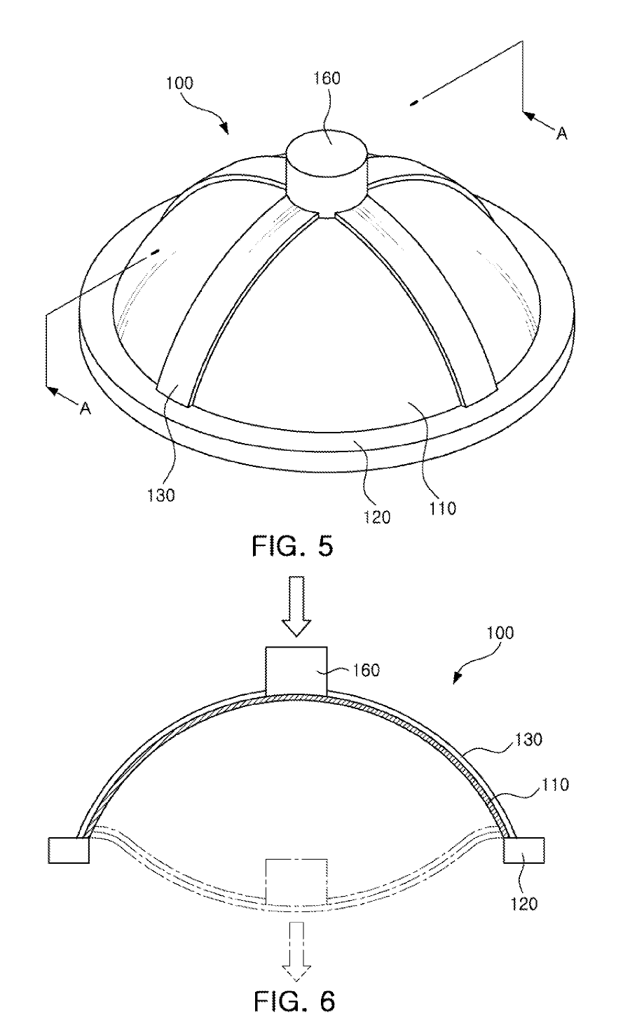

The piezoelectric energy harvester 100, according to another example, is now described further with reference to the examples of FIGS. 5 and 6.

The piezoelectric energy harvester 100, according to the present example, is distinguished from the piezoelectric energy harvester according to the example described above by a shape of a thin film member 110. For example, the thin film member 110 according to the present example has a hemispherical shape.

The thin film member 110 having the shape as described above has excellent restoring force.

As an example, the thin film member 110 is rapidly restored to an original state after a pressing operation of the user. As another example, the thin film member 110 constantly maintains an original state even after the user frequently uses the wireless switch.

Therefore, it is effective to use the piezoelectric energy harvester 100 according to the present example in a place in which a switch is frequently used.

The piezoelectric energy harvester 100, according to the present example, is distinguished from the piezoelectric energy harvester according to the example described above by a shape of a support member 120. For example, the support member 120, according to the present example, is formed to be elongated in a ring shape along an edge of the hemispherical thin film member 110.

The support member 120 having the shape as described above is advantageous for stably supporting the hemispherical thin film member 110.

The piezoelectric energy harvester 100 configured as described above obtains a great deal of piezoelectric energy by a single switching operation.

As an example, a piezoelectric member 130 generates piezoelectric energy when the thin film member 110 is deformed from a state in which the thin film member 110 is convex upward to a state in which the thin film member 110 is concave downward. In this example, the mechanical force that deforms the thin film member 110 is converted into electrical energy using the piezoelectric effect. As another example, the piezoelectric member 130 generates piezoelectric energy when the thin film member 110 is restored from the state in which the thin film member 110 is concave downward to the state in which the thin film member 110 is convex upward.

Therefore, the piezoelectric energy harvester 100 according to the present example effectively accumulates a significant amount of piezoelectric energy during a single operation.

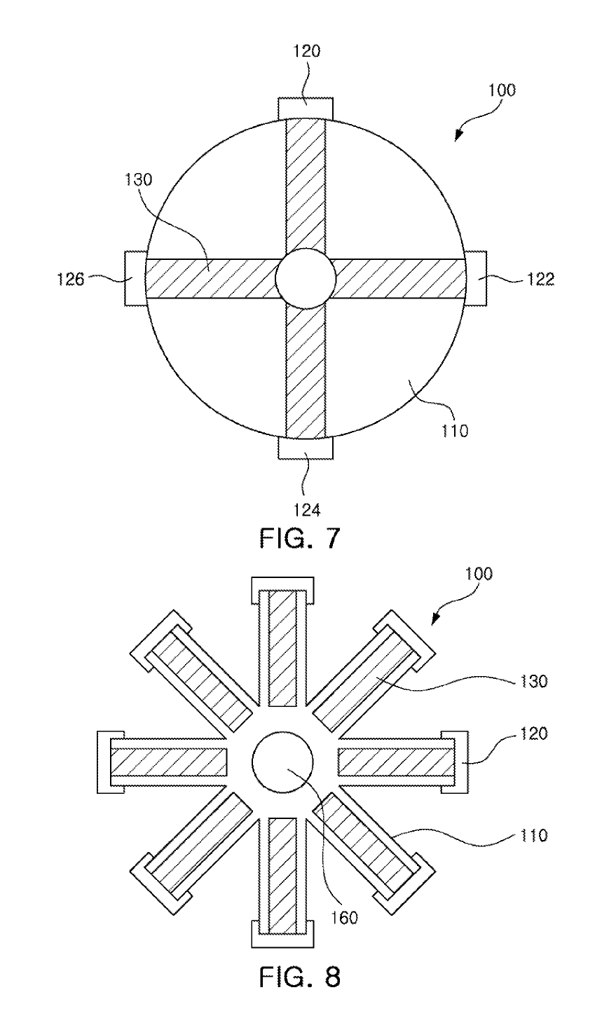

A piezoelectric energy harvester according to another example is described with reference to FIG. 7.

The piezoelectric energy harvester 100 according to the present example is distinguished from the piezoelectric energy harvesters according to the example described above by a shape of a thin film member 110 used in the example. For example, the thin film member 110 according to the present examples has a circular shape.

A piezoelectric member 130 is extended from the center of the thin film member 110 in a radial direction. For example, a diameter of the thin film member 110 and a length of the piezoelectric member 130 are the same as each other.

Support members 120, 122, 124, and 126 support only portions of the thin film member 110. For example, the support members 120, 122, 124, and 126 are disposed at portions of the thin film member in which end portions of the piezoelectric member 130 are positioned.

Since the thin film member 110 and the piezoelectric member 130 each have a plate shape, the piezoelectric energy harvester 100 configured as described above is easily manufactured.

A piezoelectric energy harvester according to another example is described further with reference to the example of FIG. 8.

The piezoelectric energy harvester 100 according to the present example is distinguished from the piezoelectric energy harvesters according to the examples described above by a shape of a thin film member 110.

The thin film member 110 according to the present example is radially extended in relation to the driving member 160. For example, the thin film member 110 is extended in eight directions in relation to the driving member 160. As another example, the thin film member 110 is extended in six directions in relation to the driving member 160.

In this example, support members 120 are disposed at ends of the thin film member 110, respectively. As an example, the support members 120 are disposed on distal ends of the thin film member 110 respectively extended in several directions. In this case, the number of support members 120 is the same as the number of extended branches of the thin film member 110. As another example, the support members 120 connects all of the distal ends of the thin film member 110 respectively extended in several directions to each other. For example, the support member 120 has a circular shape having a diameter equal to the maximum length of the thin film member 110.

Piezoelectric members 130 are formed on the thin film member 110. As an example, the piezoelectric members 130 are separately formed on the thin film member 110 respectively extended in several directions. As another example, the piezoelectric members 130 are selectively formed on portions of the thin film member 110 respectively extended in several directions.

In the piezoelectric energy harvester 100 configured as described above, since regions thereof for a plurality of piezoelectric members 130 are formed on the thin film member 110, the number of piezoelectric members 130 formed on the thin film member 110 is easily adjusted depending on a magnitude of piezoelectric energy that is required.

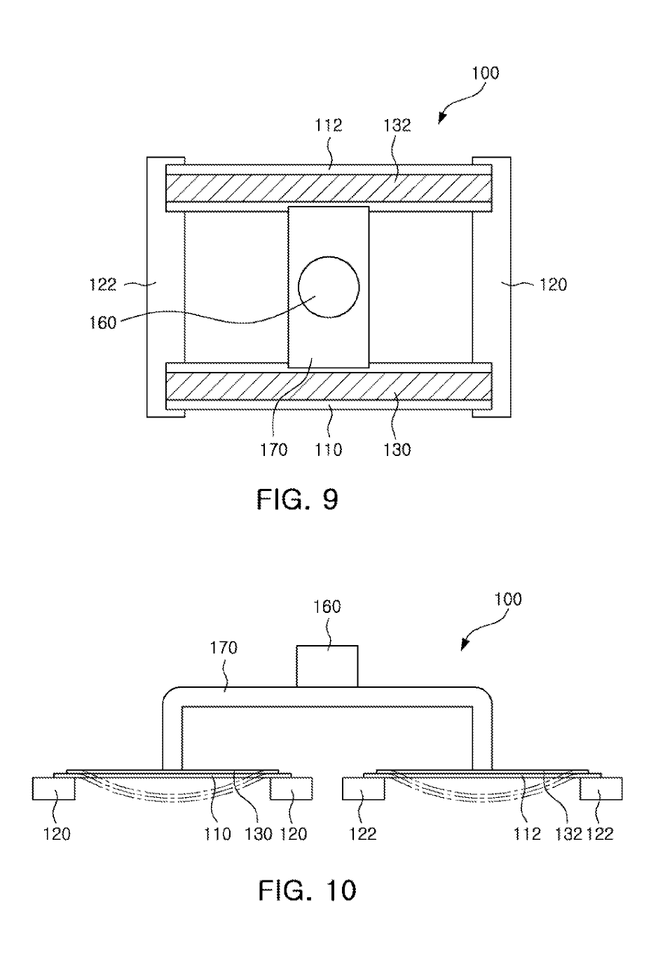

A piezoelectric energy harvester according to another example is described with reference to FIG. 9.

The piezoelectric energy harvester 100 according to the present example is distinguished from the piezoelectric energy harvesters according to the examples described above by a form in which thin film members 110 and 112 are situated. In addition, the piezoelectric energy harvester 100 according to the present example is distinguished from the piezoelectric energy harvesters according to the examples described above by the fact that the piezoelectric energy harvester 100 further includes a connection member 170.

According to the present example, the thin film members 110 and 112 are situated to be spaced apart by a predetermined interval in one direction. As an example, two thin film members 110 and 112 are disposed to be spaced apart by a predetermined interval in a width direction of the thin film members 110 and 112 as illustrated in the example of FIG. 9. As another example, three thin film members are situated equally or similarly apart as illustrated in the example of FIG. 9. As another example, four or more thin film members are situate equally or similarly apart as illustrated in the example of FIG. 9.

In an example, a pair of support members 120 and 122 are situated to support both ends of thin film members 110 and 112 separately from each other. As an example, a first support member 120 is situated to support one set of ends of the thin film members 110 and 112. As another example, a second support member 122 is disposed to support the other set of ends of the thin film members 110 and 112.

Piezoelectric members 130 and 132 are formed on the thin film members 110 and 112 differing from each other, respectively. As an example, a first piezoelectric member 130 is formed on the thin film member 110, and a second piezoelectric member 132 is formed on the thin film member 112.

The connection member 170 connects a plurality of thin film members 110 and 112 to each other. As an example, the connection member 170 connects two adjacent thin film members 110 and 112 to each other. As another example, the connection member 170 entirely connects three or more thin film members disposed to be spaced apart by a predetermined interval in one direction to each other.

The connection member 170 is situated at bisection points of the thin film members 110 and 112. For example, the connection member 170 connects the bisection point of the thin film member 110 and the bisection point of the thin film member 112 to each other. The connection member 170 configured as described above allows the plurality of thin film members 110 and 112 to move integrally with each other.

A driving member 160 is formed on the connection member 170. For example, the driving member 160 is formed at a bisection point of the connection member 170. The driving member 160 configured as described above simultaneously presses the plurality of thin film members 110 and 112 through the connection member 170. Therefore, when the user presses the driving member downward, the plurality of thin film members 110 and 112 are simultaneously bent downward, and piezoelectric energy may be generated from the piezoelectric members 130 and 132.

The piezoelectric energy harvester 100 configured as described above is effective in using a relatively small number of piezoelectric members 130 and 132.

A piezoelectric energy harvester according to another example is described with reference to FIG. 10.

The piezoelectric energy harvester 100 according to the present example is distinguished from the piezoelectric energy harvesters according to the examples described above by a form in which thin film members 110 and 112 are disposed. In addition, the piezoelectric energy harvester 100 according to the present example is distinguished from the piezoelectric energy harvesters according to the examples described above by a form in which a connection member 170 is disposed.

According to the present example, a plurality of thin film members 110 and 112 are disposed to be spaced apart by a predetermined interval in one direction. For example, two thin film members 110 and 112 are disposed to be spaced apart by a predetermined interval in a length direction of the thin film members 110 and 112 as illustrated in the example of FIG. 10. As another example, three thin film members are disposed equally or similarly as illustrated in the example of FIG. 10.

The connection member 170 connects the plurality of thin film members 110 and 112 to each other. For example, the connection member 170 connects two adjacent thin film members 110 and 112 to each other. The connection member 170 is formed at a predetermined height from the thin film members 110 and 112. To this end, both ends of the connection member 170 are extended downwards.

A driving member 160 is formed on the connection member 170. For example, the driving member 160 is formed at a bisection point of the connection member 170. The driving member 160 configured as described above simultaneously presses the plurality of thin film members 110 and 112 through the connection member 170.

As set forth above, with the piezoelectric energy harvester according to examples, impacts applied to the driving part are decreased, and thus the lifetime is increased.

Further, with the wireless switch according to examples, voltage generated in the energy harvester is used as power for generating wireless communications signals.

Unless indicated otherwise, a statement that a first layer is “on” a second layer or a substrate is to be interpreted as covering both a case where the first layer directly contacts the second layer or the substrate, and a case where one or more other layers are disposed between the first layer and the second layer or the substrate.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A piezoelectric energy harvester comprising:
a thin film member;
a support member situated to support a center or an edge of the thin film member;
a piezoelectric member situated on the thin film member; and
a driving member situated on the thin film member, situated to be misaligned with respect to the support member, and configured to press the center or the edge of the thin film member.

2. The piezoelectric energy harvester of claim 1, wherein an edge of the support member has a curved shape.

3. The piezoelectric energy harvester of claim 1, further comprising electrodes situated on the thin film member and connected to the piezoelectric member.

4. The piezoelectric energy harvester of claim 1, wherein the support member is situated to support the center of the thin film member.

5. The piezoelectric energy harvester of claim 4, wherein the driving member is situated to press the edge of the thin film member.

6. The piezoelectric energy harvester of claim 1, wherein the support member is situated to support the edge of the thin film member.

7. The piezoelectric energy harvester of claim 6, wherein the driving member is situated to press the center of the thin film member.

8. The piezoelectric energy harvester of claim 6, wherein the thin film member has a circular shape or a hemispherical shape.

9. The piezoelectric energy harvester of claim 6, wherein the thin film member radially extends in differing directions.

10. A piezoelectric energy harvester comprising:
thin film members;
support members situated to support both ends of each of the thin film members;
piezoelectric members situated on the thin film members;
a connection member connecting the centers of the thin film members; and
a driving member situated on the connection member and configured to press the connection member.

11. A wireless switch comprising:
a piezoelectric energy harvester comprising a thin film member extending in both directions based on a support member, a piezoelectric member situated on the thin film member, and a driving member configured to press upon both ends of the thin film member; and
a wireless transmission module that transmits electrical signals generated by the piezoelectric energy harvester.

12. The wireless switch of claim 11, further comprising a capacitor that accumulates energy generated from the piezoelectric energy harvester.

13. The wireless switch of claim 11, further comprising a rectifier that rectifies the electrical signals generated from the piezoelectric energy harvester.

14. The wireless switch of claim 11, further comprising a converter that converts the electric signals generated from the piezoelectric energy harvester into a drive voltage suitable for the wireless transmission module.
